(19) United States
(12) Patent Application Publication
(10) Pub. No.: US 2010/0284672 A1
(43) Pub. Date: Nov. 11, 2010

(54) VIDEO SIGNAL PROCESSING METHOD, INTEGRATED CIRCUIT, AND VIDEO REPRODUCER

(76) Inventor: Eiko Kida, Osaka (JP)

Correspondence Address: MCDERMOTT WILL & EMERY LLP, 600 13TH STREET, NW, WASHINGTON, DC, 20005-3096, US

(21) Appl. No.: 12/812,725

(22) PCT Filed: Feb. 6, 2009
(86) PCT No.: PCT/JP2009/000478

§ 371 Date: Jul. 13, 2010

(30) Foreign Application Priority Data
Feb. 7, 2008 (JP) 2008-027580
Sep. 5, 2008 (JP) 2008-002454

(51) Int. Cl. H04N 5/84; H04N 5/92

(52) U.S. Cl. 386/335; 348/448; 386/E05.061; 348/E07.003

(57) ABSTRACT

For example, in reproduction of a BD-ROM, when two streams of image data having different resolutions are displayed in a picture-in-picture mode, the difference in a sense of resolution between two windows is reduced. In an image conversion section, first image data is converted to image data in a progressive scan format by i-p conversion section, and then, the image size of the first image data is converted so that the first image data is output as third image data. The synthesizing section synthesizes the third image data with second image data, and outputs the synthesized data.

### TECHNICAL FIELD

The present invention relates to video signal processing for synthesizing two types of image data having different resolutions, which are recorded in mass storage recoding media such as Blu-ray Discs, and for outputting the synthesized data.

### BACKGROUND ART

A BD-ROM format for read only storage, which has been recently suggested, requires picture-in-picture display of two streams of image data recorded in a disk and having different resolutions, as well as the function of converting image having a standard resolution to high resolution image and of displaying the converted image.

The picture-in-picture function synthesizes two streams of image data prepared by a content producer in advance and having the same reproduction time, and displays the synthesized data. For example, resolutions and frame rates of image data for a main window and a sub-window, and a magnification factor of the size conversion in the sub-window when the image data is synthesized are defined by a standard.

In order to conform to the above-described standard, a method and a system for processing two streams of image data in parallel, synthesizing the data, and displaying the synthesized data on a single window are suggested (see, e.g., Patent Document 1). In the patent, image size conversion and synthesizing are included, thereby enabling picture-in-picture display of two streams of image data as intended by a content producer.

### SUMMARY OF THE INVENTION

### Technical Problem

However, image size conversion included in a conventional method merely performs size conversion. For example, assume that high resolution data is used for a main window, and standard resolution data is used for a sub-window. When the image data for the sub-window is expanded to a predetermined size, and is synthesized with the main window to be displayed, after being expanded to a predetermined size, there is a large difference in a sense of resolution between the two windows.

The present invention addresses this problem. For example, in reproduction of a BD-ROM, it is assumed that image data for a main window has a high resolution, image data for a sub-window has a standard resolution, and the image data for the sub-window is expanded to a predetermined image size to be displayed in a picture-in-picture mode with the main window. It is an objective of the present invention to output high-quality synthesized image with a reduced difference in a sense of resolution between the two windows, even in a case described above.

### Solution to the Problem

As a video signal processing method using first and second image data in an interlaced scan format as inputs, the present invention includes an image conversion step converting an image size of the first image data and outputting the converted data as third image data in the interlaced scan format, and a synthesizing step synthesizing the third image data with the second image data. The image conversion step includes the steps of (a) performing i-p conversion of the first image data, and (b) filtering image data in a progressive scan format, which is generated by the step (a), in accordance with a magnification factor of the image size conversion to generate the third image data.

As an integrated circuit performing video signal processing using first and second image data in an interlaced scan format as inputs; the present invention includes an image conversion section converting an image size of the first image data, and outputting obtained third image data in the interlaced scan format, and a synthesizing section synthesizing the third image data with the second image data.

The image conversion section includes an i-p conversion section performing i-p conversion of the first image data, and a size conversion section performs filtering of image data in a progressive scan format, which is generated by the i-p conversion section, in accordance with a magnification factor of the image size conversion to generate the third image data.

As a video reproducer, the present invention includes a data reproducer reproducing data in a recording medium, a video decoder decoding two independent types of compressed video data supplied from the data reproducer and outputting as first and second image data, and the integrated circuit according to the present invention inputting the first and second image data output from the video decoder.

According to the present invention, since the image size conversion is performed after the i-p conversion of the first image data, the sense of resolution can be improved as compared to a conventional method. This reduces the difference in the sense of resolution between the two windows, when e.g., the image data for the sub-window is expanded to a predetermined image size to be displayed in a picture-in-picture mode with the main window.

### ADVANTAGES OF THE INVENTION

According to the present invention, where for example, in reproduction of a BD-ROM, image data for a main window has a high resolution, and image data for a sub-window has a standard resolution, and the image data for the sub-window is expanded to a predetermined image size to be displayed in a picture-in-picture mode with the main window, high-quality synthesized image with a reduced difference in a sense of resolution between the two windows can be output.

### BRIEF DESCRIPTION OF THE DRAWINGS

FIG. 1 illustrates an example of an integrated circuit for video signal processing according to an embodiment.

FIG. 2 is a block diagram of a video reproducer according to an embodiment.

FIG. 3 illustrates fields and line positions of image data in an interlaced scan format.

FIG. 4 illustrates fields and line positions of image data, which is converted to a progressive scan format by i-p conversion.

FIG. 5 illustrates an example of vertical size conversion where image data in an interlaced scan format is an input.

FIG. 6 illustrates an example of vertical size conversion where image data converted to a progressive scan format by i-p conversion is an input.

FIG. 7 illustrates another example integrated circuit for video signal processing according to an embodiment.

FIG. 8 illustrates an example of signal processing where the magnification factor of the image size conversion is 1.

FIG. 9 illustrates an example of signal processing where the magnification factor of the image size conversion is ½.

FIG. 10 illustrates an example of signal processing where the magnification factor of the image size conversion is 2.

FIG. 11 illustrates an example of signal processing where the magnification factor of the image size conversion is 1.5.

### DESCRIPTION OF REFERENCE CHARACTERS

12, 12A Image Conversion Sections
13 I-P Conversion Section
14 Size Conversion Section
15 Synthesizing Section
21 Selector
100 Data Reproducer
101 Video Decoder
103 Integrated Circuit

### Description of Embodiments

Embodiment of the present invention will be described hereinafter with reference to the drawings.

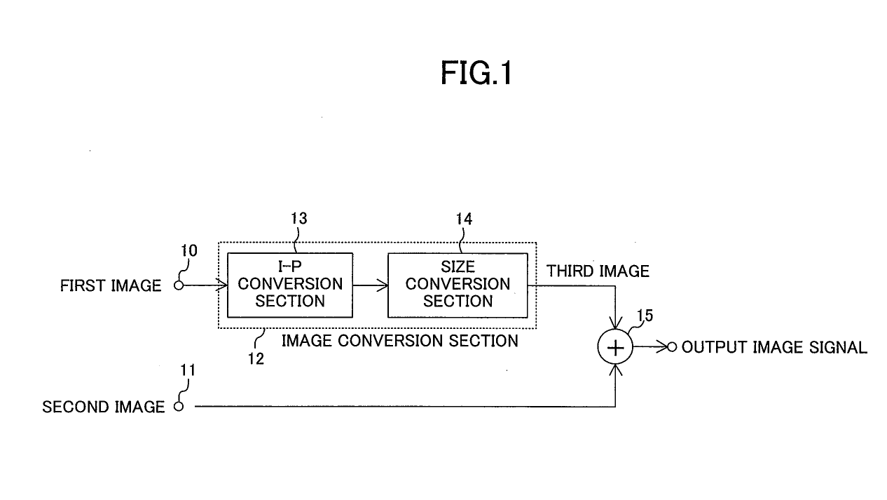

FIG. 1 illustrates an example integrated circuit for video signal processing according to this embodiment. The integrated circuit in FIG. 1 includes an input terminal 10, to which first image data is input; an input terminal 11, to which second image data is input; an image conversion section 12 converting the image size of the first image data and outputting the converted data as third image data; and a synthesizing section 15 synthesizing the third image data with the second image data. The image conversion section 12 includes an i-p conversion section 13 performing i-p conversion, a size conversion section 14 converting the image size by filtering in accordance with the magnification factor of the image size conversion. A video signal processing method according to this embodiment is implemented by the configuration shown in FIG. 1.

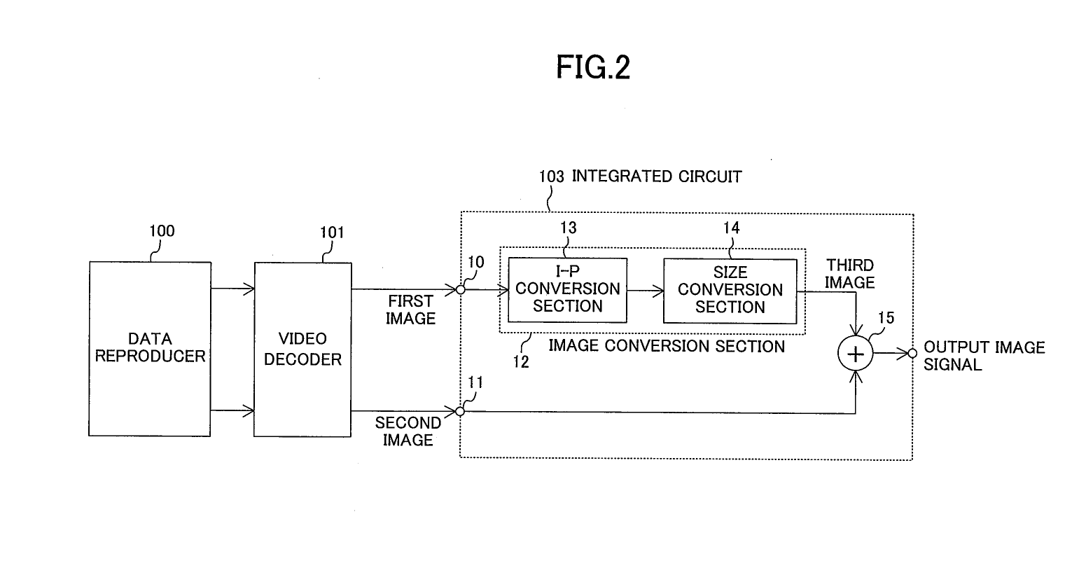

FIG. 2 is an example configuration of a video reproducer according to this embodiment. In addition to an integrated circuit 103 for video signal processing in FIG. 1, the reproducer further includes a data reproducer 100 and a video decoder 101.

The data reproducer 100 reproduces data in a recording medium and supplies two streams of compressed video data to the video decoder 101. The video decoder 101 decodes the two streams of compressed video data, and supplies the generated two streams of image data to the input terminals 10 and 11 as the first image data and the second image data, respectively.

While FIGS. 1 and 2 show examples where the integrated circuit actually includes two input terminals 10 and 11 for inputting the two streams of image data, the configuration is not limited thereto, and an input terminal may be shared. In this case, the two streams of image data are multiplexed and supplied from the single input terminal, and the multiplexed data is divided into the two streams of image data in the integrated circuit for video signal processing. The input terminal may be in a serial form or a parallel form.

Implementation of picture-in-picture display will be described below. Two independent streams of image data input in this configuration are both in an interlaced scan format. First image data has a standard resolution, and second image data has a high resolution. The second image data is for a main window, the first image data is for a sub-window, and the image data for the sub-window is expanded to be synthesized with the image data for the main window.

The i-p conversion section 13 performs the i-p conversion of the first image data in the interlaced scan format as an input, and converts the data to a progressive scan format. The size conversion section 14 performs size conversion of the image data, which has been converted to the progressive scan format, to a predetermined size; and then outputs the data as third image data. The image synthesizing section 15 synthesizes the third image data as image data for the sub-window with the second image data at a predetermined position, and outputs the synthesized data. Specifically, the image synthesizing section outputs the third image data in a region in which the third image is valid, and outputs the second image data in other regions. In the region in which the third image is valid, the third image data and the second image data may be added to be output, after being multiplied by respective predetermined coefficients. In this size conversion, the image data in the progressive scan format is an input, and image data in the interlaced format in a predetermined size is generated.

As the i-p conversion, there is e.g., a method suggested by Japanese Patent Publication No. 2000-36944. However, in the present invention, a correlation detection method in a time direction relative to accuracy of the i-p conversion, and a method of generating interpolation pixels are not limited.

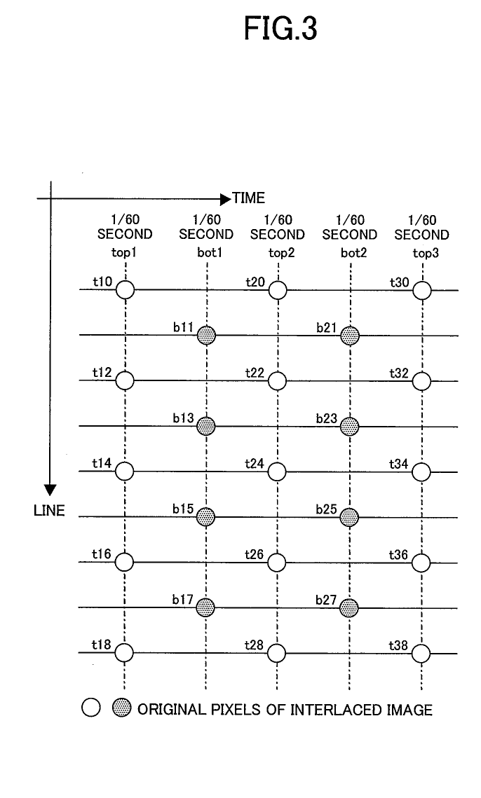

Example size conversion of image data in the size conversion section 14 will be described hereinafter with reference to FIGS. 3-6.

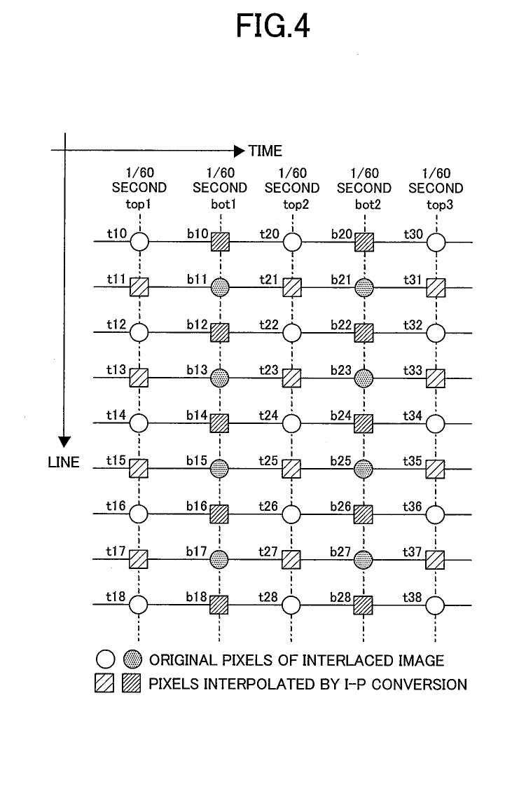

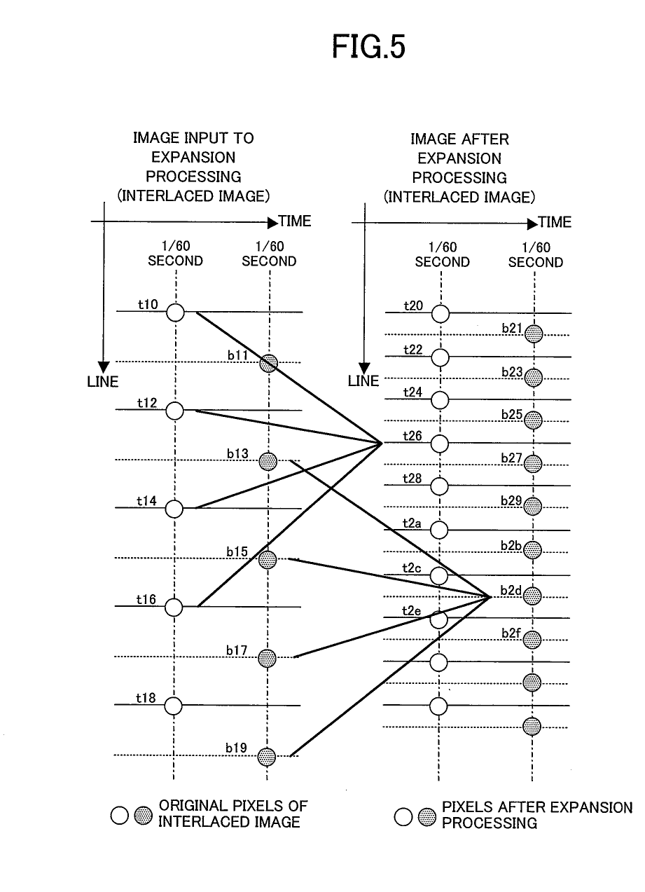

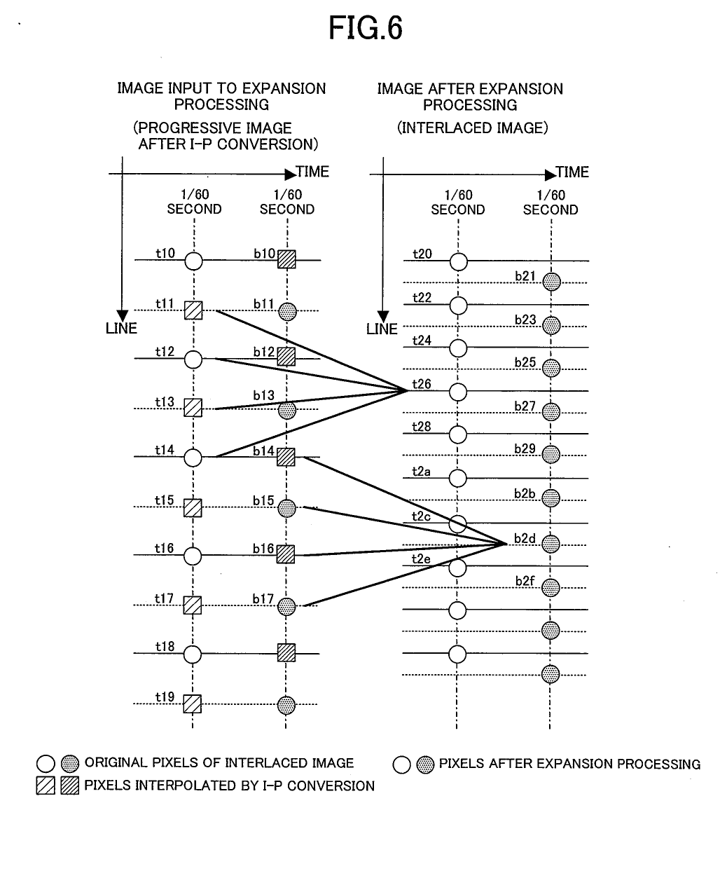

FIG. 3 illustrates the relationship between fields and line positions of image data in an interlaced scan format. FIG. 4 illustrates the relationship between fields and line positions of image data, which is converted to a progressive scan format by the i-p conversion. FIG. 5 illustrates size conversion in a vertical direction where image data in the interlaced scan format is an input. FIG. 6 illustrates size conversion in the vertical direction where image data, which is converted to the progressive scan format by i-p conversion, is an input.

In conventional size conversion in the vertical direction, image data in the interlaced scan format is an input as shown in FIG. 5. By contrast, in this embodiment, image data converted to the progressive scan format by the i-p conversion is an input as shown in FIG. 6. For example, data at t26 in FIGS. 5 and 6 is generated by filter calculation using data at t10, t12, t14, and t16 in the conventional processing shown in FIG. 5. In this embodiment, which is shown in FIG. 6, data can be generated by using data at t11, t12, t13, and t14, which are closer to the data at t26 to be interpolated with respect to vertical positions, i.e., having stronger vertical correlations.

While the vertical size conversion shown in FIGS. 5 and 6 performs interpolation using four streams of data in the vertical direction, the number of data streams for the interpolation is not limited thereto.

As described above, image data in the progressive scan format, which is generated by the i-p conversion, is used as an input; and data having a stronger vertical correlation is used to perform size conversion. This represents a further improvement in a sense of resolution compared to the image generated by expansion of the image data in the interlaced scan format.

Furthermore, the following processing may be performed when a predetermined magnification factor of the image size conversion is designated.

<Processing with Magnification Factor 1>

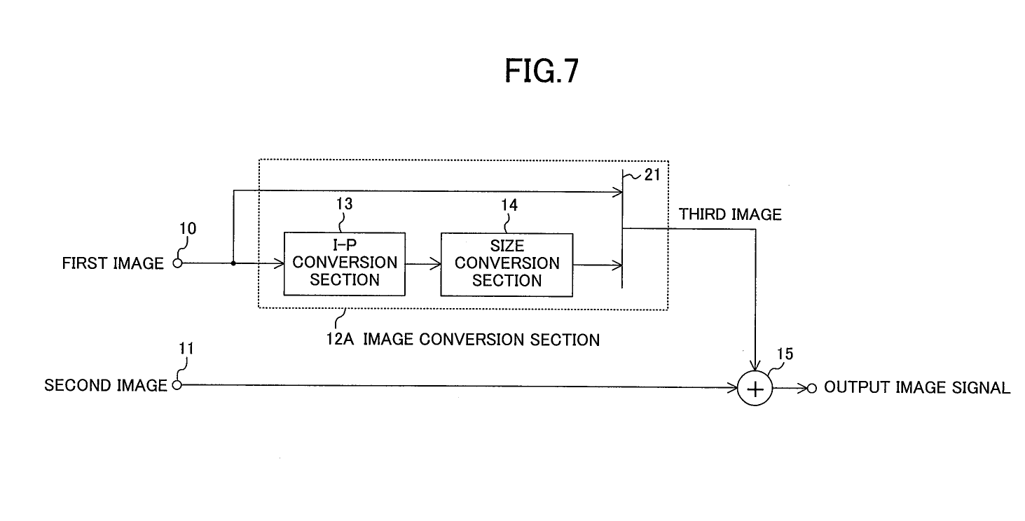

FIG. 7 illustrates another example integrated circuit for video signal processing according to this embodiment. In FIG. 7, the same reference characters as those in FIG. 1 have been used to designate identical or equivalent elements, and explanation thereof is omitted. In FIG. 7, an image conversion section 12A includes a selector 21 in addition to the i-p conversion section 13 and the size conversion section 14. The selector 21 selects either one of an output of the size conversion section 14 and the original first image data, and outputs the selected one. In this example, when the magnification factor of the image size conversion of 1 is designated, the selector 21 selects and outputs the original first image data. Thus, when the magnification factor of the image size conversion is 1, the i-p conversion and filtering according to the magnification factor of the image size conversion are not performed, and the unchanged first image data is output as third image data. That is, according to the configuration in FIG. 7, when the magnification factor of the image size conversion is 1, the filtering is omitted. This reduces the calculation amount of the image size conversion, and does not cause degradation of the image quality since the original image is output without any change.

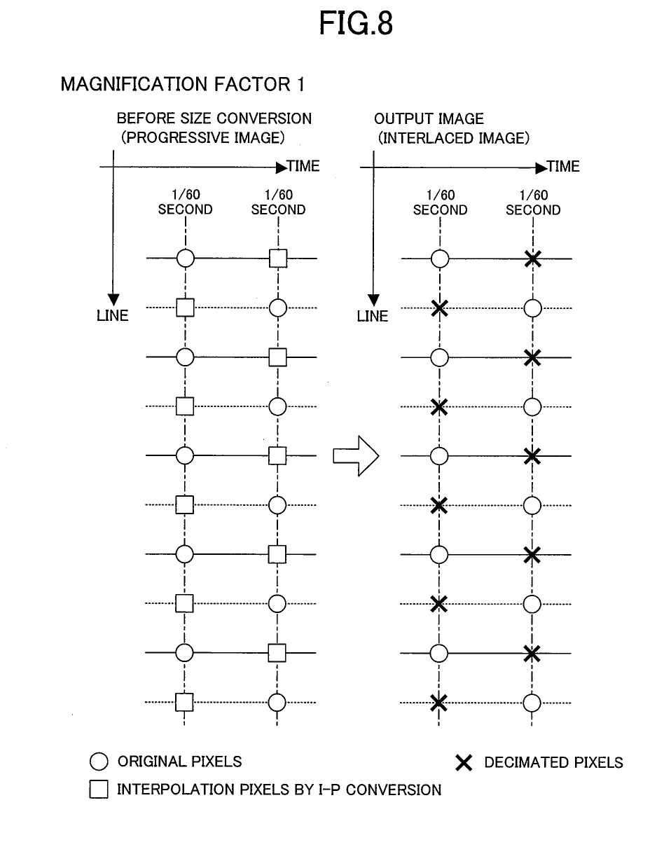

FIG. 8 illustrates another signal processing where the magnification factor of the image size conversion is 1. As shown in FIG. 8, the i-p conversion section 13 generates progressive image including original pixels and interpolation pixels. When the magnification factor of the image size conversion of 1 is designated, the size conversion section 14 decimates the interpolation pixels generated by the i-p conversion instead of the filtering. As a result, the third image data output from the size conversion section 14 is identical to the original first image data. That is, due to the processing in FIG. 8, the filtering is omitted when the magnification factor of the image size conversion is 1. This reduces the calculation amount of the image size conversion, and does not cause degradation of the image quality since the original image is output without any change.

<Processing with Magnification Factor ½>

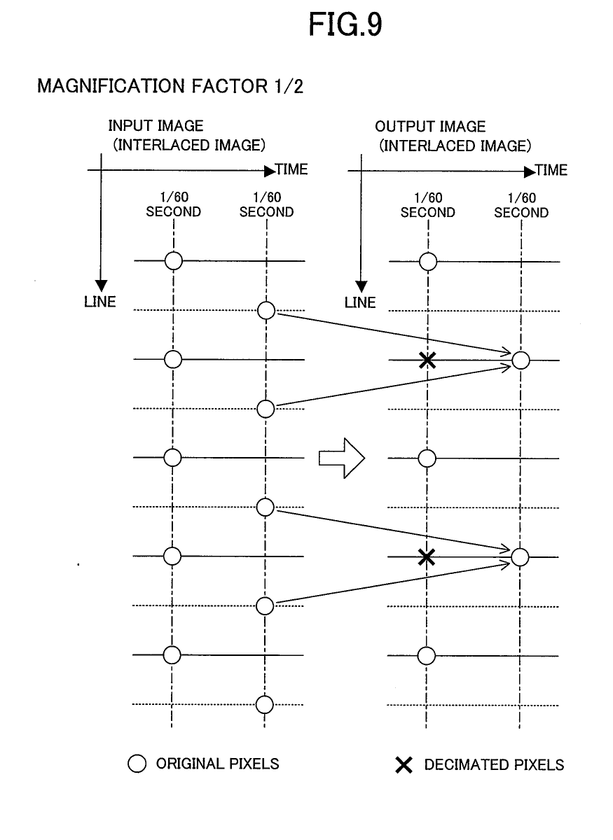

FIG. 9 illustrates an example of signal processing where the magnification factor of the image size conversion is ½. In this example, when the magnification factor of the image size conversion of ½ is designated, the i-p conversion section 13 does not execute the i-p conversion as shown in FIG. 9. That is, as shown in FIG. 9, the size conversion section 14 generates the third image data from the original first image data in the interlaced scan format. Furthermore, as shown in FIG. 9, the size conversion section 14 decimates pixels in every other field instead of the filtering to generate the third image data. That is, filtering is performed in every other field. This reduces the calculation amount of the image size conversion.

Note that, when the magnification factor of the image size conversion is ½, the signal processing shown in FIG. 9 or the signal processing executing the i-p conversion and filtering may be selectively performed in view of, e.g., the calculation amount of the image size conversion and the required quality of the images.

<Processing with Magnification Factor 2>

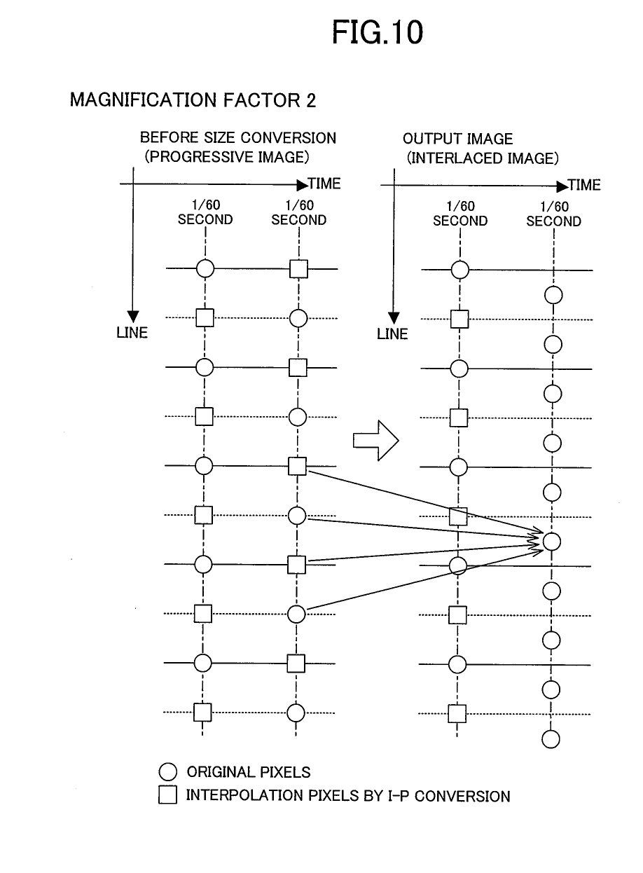

FIG. 10 illustrates an example of signal processing where the magnification factor of the image size conversion is 2. In this example, when the magnification factor of the image size conversion of 2 is designated, the size conversion section 14 performs filtering for positional shift, which shifts positions of pixels by a half pixel, in every other field as shown in FIG. 10. In the fields, in which the positional shift is not performed, filtering may be omitted. This reduces the calculation amount of the image size conversion.

Note that, in fields, in which the positional shift is not performed, filtering using an odd number of pixels including a pixel in the same position as a new pixel is performed to generate the new pixel, instead of omitting the above-described filtering.

<Processing with Magnification Factor 1.5>

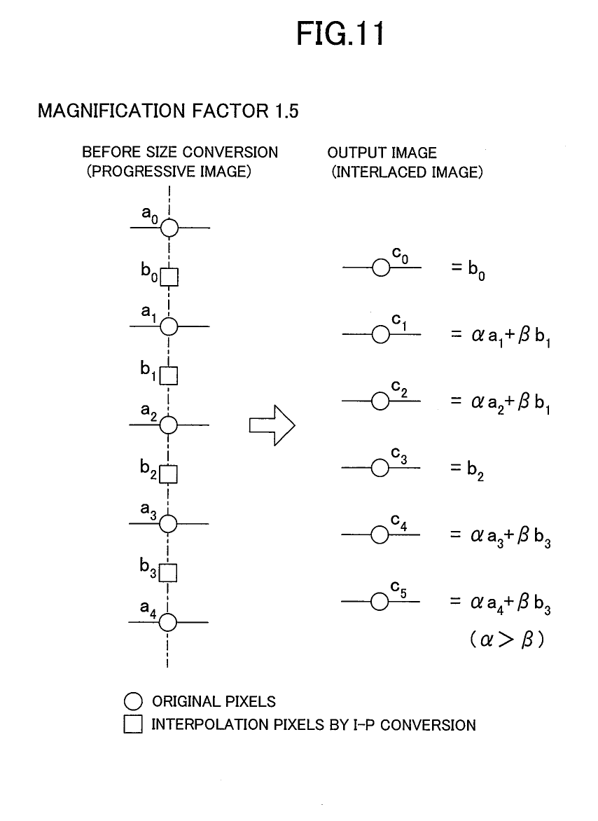

FIG. 11 illustrates an example of signal processing where the magnification factor of the image size conversion is 1.5. In FIG. 11, aᵢ represents the original pixel in the first image data, bᵢ represents an interpolation pixel generated by the i-p conversion, and cᵢ represents a new pixel generated by the size conversion. In this example, when the magnification factor of the image size conversion of 1.5 is designated, the size conversion section 14 repeats filter calculation generating three new pixels from four pixels of two original pixels and two interpolation pixels, as shown in FIG. 11. For example, in FIG. 11, new pixels c₀, c₁, and c₂ are generated from original pixels a₁ and a₂ and interpolation pixels b₀, and b₁. New pixels c₃, c₄, and c₅ are generated from original pixels a₃ and a₄, and interpolation pixels b₂ and b₃. Symbols α and β (where α>β) represent coefficients of filter calculation. This enables formation of a pattern of the filter calculation, and reduces the calculation amount of the image size conversion.

Furthermore, in the example of FIG. 11, by aligning the positions of the new pixels with those of the interpolation pixels, each filter calculation includes processing using an unchanged single interpolation pixel as a new single pixel. For example, the interpolation pixel b₀ is used as the new pixel c₀, and the interpolation pixel b₂ is used as the new pixel c₃. This further reduces the calculation amount of the image size conversion, and reduces degradation of the image quality.

With this configuration, where image data for the main window is e.g., 1080i data, and image data for a sub-window is e.g., 480i data as defined by BD-ROM format; and the image data for the sub-window is expanded to a predetermined size to be synthesized with the image data for the main window and displayed in a picture-in-picture mode, a high quality synthesized image with a reduced difference in a sense of resolution between the two windows can be provided.

Note that the resolutions of the image data input as the main window and the sub-window are not limited to those used for description of this embodiment.

### INDUSTRIAL APPLICABILITY

In the present invention, a high quality synthesized image can be output, which has a reduced difference in resolution between two windows, when two streams of image data having different resolutions are displayed in a picture-in-picture mode. Therefore, the present invention is useful for, e.g., video signal processing utilized in e.g., BD players and BD recorders, which synthesizes two types of image data having different resolutions and outputs the synthesized data.

1. A video signal processing method using first and second image data in an interlaced scan format as inputs, comprising:
an image conversion step converting an image size of the first image data and outputting the converted data as third image data in the interlaced scan format; and
a synthesizing step synthesizing the third image data with the second image data, wherein
the image conversion step includes the steps of
(a) performing i-p conversion of the first image data, and
(b) filtering image data in a progressive scan format, which is generated by the step (a), in accordance with a magnification factor of the image size conversion to generate the third image data.

2. The video signal processing method of claim 1, wherein
in the image conversion step, where the magnification factor of the image size conversion is 1, the filtering is omitted.

3. The video signal processing method of claim 2, wherein
in the image conversion step, where the magnification factor of the image size conversion is 1, the steps (a) and (b) are not performed, and the unchanged first image data is output as the third image data.

4. The video signal processing method of claim 2, wherein
in the image conversion step, where the magnification factor of the image size conversion is 1, decimation of interpolation pixels generated in the step (a) is performed in the step (b) instead of the filtering.

5. The video signal processing method of claim 1, wherein
in the image conversion step, where the magnification factor of the image size conversion is ½, pixels are decimated in every other field in the step (b) instead of the filtering without executing the step (a) to generate the third image data.

6. The video signal processing method of claim 1, wherein
in the image conversion step, where the magnification factor of the image size conversion is ½, execution of the steps (a) and (b), or decimation of pixels in every other field in the step (b) instead of the filtering without executing the step (a) is selectively performed.

7. The video signal processing method of claim 1, wherein
in the image conversion step, where the magnification factor of the image size conversion is 2, filtering for positional shift shifting positions of pixels by a half pixel is performed in every other field in the step (b).

8. The video signal processing method of claim 7, wherein
in the step (b), the filtering is omitted in fields, in which the positional shift is not performed.

9. The video signal processing method of claim 7, wherein
in the step (b), filtering using an odd number of pixels including a pixel in the same position as a new pixel is performed to generate the new pixel in fields, in which the positional shift is not performed.

10. The video signal processing method of claim 1, wherein
in the image conversion step, where the magnification factor of the image size conversion is 1.5, filter calculation, which generates three new pixels from four pixels of two original pixels in the first image data and two interpolation pixels generated by the step (a), is repeated in the step (b).

11. The video signal processing method of claim 10, wherein
the filter calculation includes processing using a single interpolation pixel as a new single pixel.

12. An integrated circuit performing video signal processing using first and second image data in an interlaced scan format as inputs, the circuit comprising:
an image conversion section converting an image size of the first image data, and outputting obtained third image data in the interlaced scan format; and
a synthesizing section synthesizing the third image data with the second image data, wherein
the image conversion section includes
an i-p conversion section performing i-p conversion of the first image data, and
a size conversion section performs filtering of image data in a progressive scan format, which is generated by the i-p conversion section, in accordance with a magnification factor of the image size conversion to generate the third image data.

13. The integrated circuit of claim 12, wherein
the image conversion section omits filtering, where the magnification factor of the image size conversion is 1.

14. The integrated circuit of claim 13, wherein
the image conversion section outputs the unchanged first image data as the third image data, where the magnification factor of the image size conversion is 1.

15. The integrated circuit of claim 13, wherein
in the image conversion section, where the magnification factor of the image size conversion is 1, the size conversion section performs decimation of interpolation pixels generated by the i-p conversion section instead of the filtering.

16. The integrated circuit of claim 12, wherein
in the image conversion section, where the magnification factor of the image size conversion is ½, the i-p conversion section does not execute the i-p conversion, and the size conversion section decimates pixels in every other field instead of the filtering to generate the third image data.

17. The integrated circuit of claim 12, wherein
in the image conversion section, where the magnification factor of the image size conversion is ½, processing, in which the i-p conversion section executes the i-p conversion, and the size conversion section executes filtering; or processing, in which the i-p conversion section does not execute the i-p conversion, and the size conversion section decimates pixels in every other filed instead of the filtering, is selectively performed.

18. The integrated circuit of claim 12, wherein
in the image conversion section, where the magnification factor of the image size conversion is 2, the size conversion section performs filtering for positional shift shifting positions of pixels by a half pixel in every other field.

19. The integrated circuit of claim 18, wherein
the size conversion section omits the filtering in fields, in which the positional shift is not performed.

20. The integrated circuit of claim 18, wherein
the size conversion section executes filtering using an odd number of pixels including a pixel in the same position as a new pixel to generate the new pixel in fields, in which the positional shift is not performed.

21. The integrated circuit of claim 12, wherein
in the image conversion section, where the magnification factor of the image size conversion is 1.5, the size conversion section repeats filter calculation, which generates three new pixels from four pixels of two original pixels in the first image data and two interpolation pixels generated by the i-p conversion section.

22. The integrated circuit of claim 21, wherein
the filter calculation includes processing using a single interpolation pixel as a new single pixel.

23. A video reproducer comprising:
a data reproducer reproducing data in a recording medium;
a video decoder decoding two independent types of compressed video data supplied from the data reproducer and outputting as first and second image data; and
the integrated circuit of claim 12 inputting the first and second image data output from the video decoder.
